(19) United States
(12) Patent Application Publication
(10) Pub. No.: US 2025/0376644 A1
(43) Pub. Date: Dec. 11, 2025

(54) Dishwashing Detergent Composition

(71) Applicant: Reckitt Benckiser Finish B.V., Hoofddorp (NL)

(72) Inventors: Alias Younis AL-BAYATI, Heidelberg (DE); Adrian BARTHOLOMÄ, Heidelberg (DE); Pascal Joachim KOZIOL, Heidelberg (DE); Torsten ROTH, Heidelberg (DE); Divya VARADHARAJAN, Heidelberg (DE); Nils WEDLER, Heidelberg (DE); Qingcai ZHAO, Heidelberg (DE)

(21) Appl. No.: 18/874,214

(22) PCT Filed: Jun. 22, 2023
(86) PCT No.: PCT/EP2023/066951

§ 371 Date: Dec. 12, 2024

(30) Foreign Application Priority Data
Jun. 29, 2022 (GB) 2209523.6

(51) Int. Cl. C11D 7/26

(52) U.S. Cl. CPC C11D 7/268

(57) ABSTRACT

The present invention is related to a dishwashing, preferably an automatic dishwashing, detergent composition wherein the detergent composition comprises at least one reducing monosaccharide and/or at least one reducing disaccharide.

The present invention is also related to the use of such an inventive dishwashing, preferably an automatic dishwashing, detergent composition for silver corrosion protection of silver dishes during a dishwashing, preferably during an automatic dishwashing, process.

Furthermore, the present invention is related to the use of a dishwashing, preferably an automatic dishwashing, detergent composition comprising tamarind extract, which comprises a mixture of reducing monosaccharides and reducing disaccharides for silver corrosion protection of silver dishes during a dishwashing, preferably during an automatic dishwashing, process.

### FIELD OF THE INVENTION

The present invention relates to a dishwashing, preferably an automatic dishwashing, detergent composition.

The present invention is also related to the use of such an inventive dishwashing, preferably an automatic dishwashing, detergent composition for silver corrosion protection of silver dishes during a dishwashing, preferably during an automatic dishwashing, process.

Furthermore, the present invention is related to the use of a dishwashing, preferably an automatic dishwashing, detergent composition comprising tamarind extract, which comprises a mixture of reducing monosaccharides and reducing disaccharides for silver corrosion protection of silver dishes during a dishwashing, preferably during an automatic dishwashing, process.

### BACKGROUND OF THE INVENTION

The inclusion of a silver/copper corrosion inhibitor in an automatic dishwashing detergent composition has been widely used since a long time by consumers for protecting their silver/copper dishwashing goods.

A diverse array of compositions designed for use in automatic dishwasher machines is well known, and a consistent and ongoing effort has been made by detergent manufacturers to reduce the tarnishing of silver and copper items and surfaces in the dishwasher. This problem becomes apparent when bleach-containing compositions are employed, and especially those which contain oxygen-bleaching species. The level of tarnishing observed can range from slight discoloration to the formation of a dense black coating on the surface of the silverware or copperware, depending on the formulation and the bleaching agent. The dual challenge in formulating a product is therefore the optimization of the cleaning of bleachable soils while minimizing the occurrence of tarnishing of silverware items.

Existing formulations achieve this through the inclusion of BTA (1H-benzotriazole) and/or TTA (a mixture of 4-methyl-1H-benzotriazole and 5-methyl-1H-benzotriazole). BTA and TTA are both effective at reducing the tarnishing of silverware components in the presence of bleaching agents. However, BTA was found to be toxic to aquatic life and, in addition, is a potential endocrine disruptor (Seeland et al., J. Environ. Sci. Pollut. Res. Int, 2012, 19(5), 1781-1790.

While alternatives to BTA were initially identified, e.g. tellurium and selenium dioxide, they have been dismissed due concerns over toxicity. Moreover, reformulation efforts focusing on increased disilicate levels did not yield a viable formula with an improved anti-corrosion profile without exceeding regulatory limits. In the following years, BTA was exchanged by TTA in the formulations due to increasing indications of adverse effects of BTA. However, in recent years several studies have found that TTA (specifically the 4-methyl isomer) are harmful to the aquatic environment (see Brauch et. al., Water Research and Management, 2011, Vol. 1, No. 1, 17-28 and Huntscha et. al., J. Environ. Sci. Technol., 2014, 48, 4435-4443). Because TTA contains a significant quantity of the 4-methyl-1H-benzotriazole, existing bleach-containing automatic dishwashing compositions that are effective in minimizing silver and copper tarnishing are also harmful to the aquatic environment.

There is therefore still an increasing need to replace the currently used BTA/TTA as raw materials against silver corrosion in automatic dishwashing (ADW) compositions owing to their poor sustainability profile and regulations that will soon prevent their use in detergent compositions.

Along these lines, the explored routes to tackle this problem is until now limited to imidazole-based small molecules, sulfur or thiol containing amino acids such as cystin and cysteine, and specific redox-active substances.

### OBJECTIVE OF THE PRESENT INVENTION

In view of the prior art, it was thus an object of the present invention to provide a new alternative composition for silver protection in dishwashing processes, which shall not exhibit the aforementioned shortcomings of the known prior art dishwashing compositions.

In particular, it was an object of the present invention to provide a new alternative composition for silver protection in dishwashing processes, which shall reduce the release of harmful and less biodegradable benzotriazoles into the environment.

Furthermore, it was an object to provide a new alternative composition for silver protection in dishwashing processes, which is of comparable efficacy in inhibiting silver corrosion compared to the use of compositions comprising BTA and/or TTA.

### SUMMARY OF THE INVENTION

These objects and also further objects which are not stated explicitly but are immediately derivable or discernible from the connections discussed herein by way of introduction are achieved by a dishwashing, preferably an automatic dishwashing, detergent composition having all features of claim 1. Appropriate modifications to the inventive dishwashing, preferably an automatic dishwashing, detergent composition are protected in dependent claims 2 to 13. Claim 14 relates to the use of such an inventive dishwashing, preferably an automatic dishwashing, detergent composition for silver corrosion protection of silver dishes during a dishwashing, preferably during an automatic dishwashing, process; while claim 15 relates to the use of a dishwashing, preferably an automatic dishwashing, detergent composition comprising tamarind extract, which comprises a mixture of reducing monosaccharides and reducing disaccharides for silver corrosion protection of silver dishes during a dishwashing, preferably during an automatic dishwashing, process.

The present invention accordingly provides a dishwashing, preferably an automatic dishwashing, detergent composition wherein the detergent composition comprises at least one reducing monosaccharide and/or at least one reducing disaccharide.

It is thus possible in an unforeseeable manner to provide a new alternative composition for silver protection in dishwashing processes, which does not exhibit the aforementioned shortcomings of the known prior art dishwashing compositions.

In addition thereto, the new alternative composition for silver protection in dishwashing processes reduces the release of harmful and less biodegradable benzotriazoles into the environment.

Furthermore, the new alternative composition for silver protection in dishwashing processes is of comparable efficacy in inhibiting silver corrosion compared to the use of compositions comprising BTA and/or TTA.

### BRIEF DESCRIPTION OF THE TABLES

Objects, features, and advantages of the present invention will also become apparent upon reading the following description in conjunction with the tables, in which:

Table 1 exhibits a comparison of comparative and inventive formulations.

Table 2 exhibits a comparison of further comparative and inventive formulations.

Table 3 exhibits information about the individual silver corrosion protection compounds used in the comparative and inventive formulations of Tables 1 and 2.

Table 4 exhibits information about the mixtures of individual silver corrosion protection compounds used in the comparative and inventive formulations of Tables 1 and 2.

### DETAILED DESCRIPTION OF THE INVENTION

As used herein, the term “reducing monosaccharide” or “reducing disaccharide”, in accordance with the present invention, refers to a monosaccharide or disaccharide, which can act as a reducing agent.

If such a “reducing monosaccharide” or “reducing disaccharide” is present, can be easily determined by standard procedures such as by a Benedict's reagent.

The Benedict's reagent is a chemical reagent and complex mixture of sodium carbonate, sodium citrate, and copper (II) sulphate pentahydrate. It is often used in place of Fehling's solution to detect the presence of reducing sugars. A positive test with Benedict's reagent is shown by a colour change from clear blue to brick-red with a precipitate.

In one embodiment, the detergent composition is essentially free, preferably completely free, of any triazole, in particular of BTA and TTA.

The expression “essentially free” means in the context of the present invention a concentration of less than 5 wt %, preferably less than 3 wt %, and more preferably less than 0.5 wt %.

In one embodiment, the at least one reducing monosaccharide is selected from the group consisting of glucose, fructose, galactose, deoxyribose, ribose, xylose, arabinose, lyxose, allose, altrose, mannose, gulose, iodose, and talose.

In one embodiment, the at least one reducing disaccharide is selected from the group consisting of maltose, lactose, cellobiose, melibiose, chitobiose, kojibiose, nigerose, Isomaltose, sophorose, laminaribiose, gentiobiose, trehalulose, turanose, maltulose, leucrose, isomaltulose, gentiobiulose, mannobiose, melibiulose, rutinose, rutinulose, and xylobiose.

In one embodiment, the at least one reducing monosaccharide is selected from the group consisting of glucose, fructose, galactose, and arabinose; while the at least one reducing disaccharide is selected from the group consisting of maltose, lactose, cellobiose, and melibiose.

In one embodiment, the detergent composition further comprises at least one non-reducing monosaccharide and/or at least one non-reducing disaccharide.

In a preferred embodiment thereof, the detergent composition further comprises at least sucrose and/or trehalose.

In another embodiment, the detergent composition is essentially free, preferably completely free, of any non-reducing monosaccharide and non-reducing disaccharide.

In one embodiment, the detergent composition comprises at least two different reducing disaccharides.

In a preferred embodiment thereof, the detergent composition comprises two different reducing disaccharides with the proviso that no other reducing monosaccharides or reducing disaccharides are comprised.

In an even more preferred embodiment thereof, the two different reducing disaccharides are cellobiose and melibiose.

In one embodiment, the detergent composition is essentially free, preferably completely free, of any other reducing agent besides reducing monosaccharides and/or reducing disaccharides.

In one embodiment, said detergent composition comprises 0.1 to 5 wt %, preferably 0.25 to 3 wt %, and more preferably 0.4 to 1.2 wt % of said reducing monosaccharides and reducing disaccharides in total.

As used herein, the terms “wt %”, “% wt.”, “weight %”, and “% by weight” are synonyms to each other. All of these expressions are referring to a weight percentage of the respective component.

The dishwashing, preferably automatic dishwashing, detergent composition of the present invention can comprise a builder.

The builder may be a phosphate-free builder. In many countries, including the United States and in the European Union, phosphate builders are restricted, or the amount of phosphate permitted in a detergent composition has been severely limited. Therefore, in preferred embodiments, the detergent compositions are substantially phosphate-free.

The builder comprises one or more small molecule builders selected from hydroxycarboxylates (such as a citrate salt, for example trisodium citrate, which may be anhydrous), aminocarboxylates (such as methyl glycine diacetic acid (MGDA), or N,N-dicarboxymethyl glutamic acid (GLDA), dicarboxylic acid amines (such as iminodisuccinic acid (IDS)) and/or phosphates (such as tripolyphosphate), or the salts thereof.

The builder may be present in an amount of greater than 10% wt., 15% wt., 20% wt., 25% wt., 30 wt. %, 35% wt., 40% wt., 45% wt., or greater than 50% wt. The builder may be present in an amount between 31 and 49 wt. %, between 32 and 41% wt., or between 33 and 39% wt.

The builder may be present in an amount up to 0.1% wt., 0.2% wt., 0.3% wt., 0.4% wt., 0.5% wt., 0.6% wt., 0.7% wt., 0.8% wt., 0.9% wt., 1% wt., 1.5% wt., 2% wt., 3% wt., 4% wt., 5% wt., 6% wt., 7% wt., 8% wt., 9% wt. or up to 10% wt.

The actual amount used in the detergent composition may depend upon the nature of the builder used.

The builder may be an organic builder.

The detergent composition may comprise a secondary builder (co-builder), for example a phosphonate, such as tetrasodium-HEDP.

The dishwashing, preferably automatic dishwashing, detergent composition of the present invention can comprise at least one polymer, preferably at least one polycarboxylate. By the term ‘polycarboxylate’, we mean any polymeric species comprising a carboxylic acid or carboxylate groups available for chelation. The polycarboxylate polymer may be a homopolymer and/or a copolymer and/or a terpolymer.

The one or more polymer may be present in an amount of between 3 and 25% wt., between 5 and 20% wt., between 6 and 18% wt., between 7 and 16% wt., between 8 and 15% wt., or between 9 and 13% wt.

The polymer may be a polycarboxylate polymer comprising an itaconic acid copolymer.

The polymer may be a polycarboxylate polymer comprising an acrylic acid monomer.

The polymer may be a polycarboxylate polymer comprising an acrylic acid homopolymer. The homopolymer may have a number average molecular weight of between 2,000 and 10,000, between 3,000 and 9,000, or between 4,000 and 8,000. The homopolymer may be present in an amount of from 0.1 to 5% wt., from 0.2 to 4.5% wt., from 0.3 to 4% wt., from 0.3 to 3.5% wt., from 0.4 to 3% wt., from 0.5 to 2.5% wt., from 0.6 to 2% wt., or from 0.7 to 1.5% wt.

The at least one polycarboxylate may comprise a sulphonic acid monomer. The sulphonic acid monomer may be present in an amount of from 4 to 14% wt., from 5 to 13% wt., from 6 to 12% wt. or from 7 to 11% wt.

Preferred monomers containing sulphonic acid groups are those of the formula:

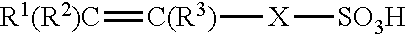

in which R¹ to R³ mutually independently denote —CH3, a straight-chain or branched saturated alkyl residue with 2 to 12 carbon atoms, a straight-chain or branched, mono-or polyunsaturated alkenyl residue with 2 to 12 carbon atoms, alkyl or alkenyl residues substituted with —NH2, —OH or —COOH, or denote —COOH or —COOR⁴, R⁴ being a saturated or unsaturated, straight-chain or branched hydrocarbon residue with 1 to 12 carbon atoms, and X denotes an optionally present spacer group which is selected from —(CH₂)n— with n=0 to 4, —COO—(CH₂)k— with k=1 to 6, —C(O)—NH—C (CH₃)₂— and CH(CH₂CH₃)—.

Preferred monomers of the above formula include, for example, those of the formulae:

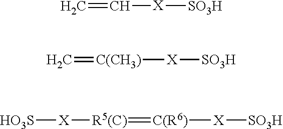

in which R⁵ and R⁶ are mutually independently selected from —H, —CH₃, —CH₂CH₃, —CH₂CH₂CH₃, —CH(CH₃)₂ and X denotes an optionally present spacer group which is selected from —(CH₂)n— with n=0 to 4, —COO—(CH₂)k with k=1 to 6, —C(O)—NH—C(CH₃)₂— and —C(O)—NH—CH(CH₂CH₃)—.

Preferred monomers containing sulphonic acid groups are here 1-acrylamido-1-propanesulphonic acid, 2-acrylamido-2-propanesulphonic acid, 2-acrylamido-2-methyl-1-propanesulphonic acid, 2-methacrylamido-2-methyl-1-propanesulphonic acid, 3-methacrylamido-2-hydroxypropane-sulphonic acid, allylsulphonic acid, methallylsulphonic acid, allyloxybenzenesulphonic acid, methallyloxybenzenesulphonic acid, 2-hydroxy-3-(2-propenyloxy)propanesulphonic acid, 2-methyl-2-propene-1-sulphonic acid, styrenesulphonic acid, vinylsulphonic acid, 3-sulphopropyl acrylate, 3-sulfopropyl methacrylate, sulphomethacrylamide, sulphomethylmethacrylamide and mixtures of the stated acids or the watersoluble salts thereof. Particularly preferred is 2-acrylamido-2-methyl-1-propane-sulphonic acid.

The sulphonic acid groups may be present in the polymers entirely or in part in neutralized form, i.e. the acidic hydrogen atom of the sulphonic acid group may be replaced in some or all of the sulphonic acid groups with metal ions, preferably alkali metal ions and in particular with sodium ions. It is preferred according to the invention to use copolymers containing partially or completely neutralized sulphonic acid groups.

The molar mass of the sulphonic acid polymers may be varied in order to tailor the properties of the polymers to the desired intended application. The copolymers may have a number average molecular weight of between 2000 and 200,000 g mol⁻¹, between 4000 and 25,000 g mol⁻¹, or between 5000 and 15,000 g mol⁻¹. The polymer preferably has a pH of from 3 to 5, such as from 3.5 to 4.5.

The polycarboxylate may be a copolymer comprising a sulphonic acid monomer and an acrylic acid monomer.

The at least one polycarboxylate comprises a maleic acid monomer. Such a polymer is preferably present in an amount of from 0.1 to 5wt., from 0.2 to 4.5% wt., from 0.3 to 4% wt., from 0.3 to 3.5% wt., from 0.4 to 3% wt., from 0.5 to 2.5% wt., from 0.6 to 2% wt., or from 0.7 to 1.5% wt.

The polymer may have a viscosity of from 500 to 3000 mPa·s, from 750 to 2500 mPa·s, from 1000 mPa·s to 2000 mPa·s. Such a copolymer may have a weight average molecular weight from 10,000 to 100,000 g mol⁻¹, from 20,000 to 80,000 g mol⁻¹, from 30,000 to 70,000 g mol⁻¹, or from 45,000 to 55,000 g mol¹.

The polycarboxylate may be a copolymer comprising a maleic acid monomer and an acrylic acid monomer.

The acrylic acid-maleic acid copolymer may be formed from 2-propenoic acid and 2,5-furandione. The acrylic acid-maleic acid copolymer may have a pH of from 7 to 9, such as from 7.5 to 8.5, assessed by DIN19268.

The polymer may be an acrylic acid homopolymer, an acrylic acid-sulphonic acid, and/or an acrylic acid-maleic acid copolymer.

The polymer may comprise one or more polycarboxylate homopolymers and one or more polycarboxylate copolymers. The homopolymer(s) and copolymer(s) may be present in a ratio of from 1:20 to 1:2, preferably from 1:15 to 1:5.

The polymer may comprise polyepoxysuccinic acid (PESA) or derivatives thereof. Polyepoxysuccinic acid is also known as epoxysuccinic acid homopolymer, polyoxirane-2,3-dicarboxylic acid, 2,3-oxiranedicarboxylic acid homopolymer, or poly(1-oxacyclopropane-2,3-dicarboxylic acid); and has the general structure:

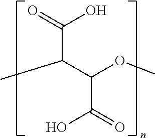

and where the derivatives thereof have the general structure:

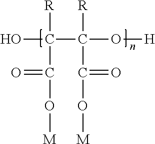

where R may be hydrogen or any organic chain (but preferably an ester such as C₁₋₄ alkyl) and where M may be any cation (preferably Na⁺, H⁺, K⁺, and/or NH₄⁺).

All references to PESA hereafter are to be taken to refer to polyepoxysuccinic acid or derivatives thereof, unless otherwise stated.

The PESA may have a weight average molecular weight from 100 to 10,000 g mol⁻¹, from 400 to 2000 g mol⁻¹, from 1000 to 1800 g mol⁻¹. The PESA may have from 2 to 100 repeating monomer units, such as from 2 to 50, 2 to 45, 2 to 20 or from 2 to 10 repeating monomer units.

The polymer may comprise PESA in an amount from 0.1 to 5% wt., from 0.1 to 4% wt., from 0.15 to 3% wt., from 0.2 to 1.9% wt., from 0.25 to 1.5% wt., or from 0.6 to 1.1% wt. PESA is preferably present in an amount from 5 to 20% wt., from 8 to 19% wt., or from 9 to 15% wt., relative to the total quantity of polymers present.

The polymer may comprise any biodegradable polymer.

The biodegradable polymer may comprise, for example, Alcoguard (®) H 5941.

The biodegradable polymer may comprise a bio-based carbohydrate backbone, for example starch, cellulose or inulin. The polymer may comprise one or more synthetic, fossil-based grafting group.

The polymer may be a cationic, anionic or amphoteric polymer.

The dishwashing, preferably automatic dishwashing, detergent composition of the present invention can comprise one or more surfactant(s). Any of nonionic, anionic, cationic, amphoteric or zwitterionic surface active agents or suitable mixtures thereof may be used. Many such suitable surfactants are described in Kirk Othmer's Encyclopedia of Chemical Technology, 3rd Ed., Vol. 22, pp. 360-379, “Surfactants and Detersive Systems”, incorporated by reference herein. Preferably, bleach-stable surfactants may be used.

In the case of automatic dishwashing compositions, it is preferred to minimise the amount of anionic surfactant. Accordingly, preferably the composition comprises no more than 15% wt., no more than 10% wt., no more than 5% wt., no more than 2% wt., no more than 1% wt., or no anionic surfactant. Preferably the composition comprises no more than 15% wt., no more than 10% wt., no more than 5% wt., no more than 2% wt., no more than 1% wt., or no ionic surfactant of any type.

Non-ionic surfactants are preferred for automatic dishwashing products. The composition may comprise from 5 to 25% wt., from 10 to 20% wt., from 11 to 19% wt., from 12 to 18% wt., from 13 to 17% wt., from 14 to 16% wt., or 15% wt. of one or more non-ionic surfactants.

The non-ionic surfactant may be an optionally end capped alkyl alkoxylate. A preferred class of non-ionic surfactants are ethoxylated non-ionic surfactants prepared by the reaction of a monohydroxy alkanol or alkyl phenol with 6 to 20 carbon atoms. Preferably the surfactants have at least 12 moles per mole of alcohol or alkyl phenol. Particularly preferred non-ionic surfactants are the nonionics from a linear chain fatty alcohol with 10-20 carbon atoms and at least 5 moles of ethylene oxide per mole of alcohol. The non-ionic surfactant may comprise propylene oxide (PO) units in the molecule. The PO units may constitute up to 40% wt., 35% wt., 30% wt., 25% wt., 20% wt. or up to 15% wt. of the overall molecular weight of the non-ionic surfactant.

The use of a mixture of any of the aforementioned non-ionic surfactants is suitable in compositions of the present invention.

The dishwashing, preferably automatic dishwashing, detergent composition of the present invention can comprise one or more enzymes. It is preferred that the one or more enzymes are selected from protease, lipase, amylase, cellulase and peroxidase, with protease and amylase being most preferred. It is most preferred that protease and/or amylase enzymes are included in the compositions according to the invention as such enzymes are especially effective in dishwashing detergent compositions.

The one or more enzyme may be present in an amount from 1 to 40% wt., from 2 to 38% wt., from 4 to 36% wt., from 6 to 34% wt., from 8 to 32% wt., from 10 to 30% wt., from 12 to 28% wt., from 14 to 26% wt., from 16 to 24% wt., from 18 to 24% wt. from 20 to 24% wt., from 22 to 24% wt., or 23% wt. based on the weight of the detergent composition.

The dishwashing, preferably automatic dishwashing, detergent composition of the present invention can comprise one or more bleaching agents, preferably in combination with one or more bleach activators and/or one or more bleach catalysts. The one or more bleaching agent is preferably selected from the group consisting of an oxygen-releasing bleaching agent, a chlorine-releasing bleaching agent and mixtures thereof.

The bleaching agent may comprise the active bleach species itself or a precursor to that species. The bleaching agent may be selected from the group consisting of an inorganic peroxide, an organic peracid and mixtures thereof. The terms “inorganic peroxide” and “organic peracid” encompass salts and derivatives thereof. Inorganic peroxides include percarbonates, perborates, persulphates, hydrogen peroxide and derivatives and salts thereof. The sodium and potassium salts of these inorganic peroxides are suitable, especially the sodium salts. Sodium percarbonate is particularly preferred.

The active bleaching agent is preferably present in an amount from 5 to 25% wt., from 7 to 23% wt., from 9 to 19% wt., or from 11 to 17% wt.

The detergent composition may further comprise one or more bleach activators and/or bleach catalysts. Any suitable bleach activator may be included, for example Tetraacetylethylenediamine (TAED), if this is desired for the activation of the bleaching agent. Any suitable bleach catalyst may be used, for example manganese acetate or dinuclear manganese complexes such as those described in EP 1741774 A1, the contents of which are incorporated herein by reference. The organic peracids such as perbenzoic acid and peroxycarboxylic acids e.g. phthalimidoperoxyhexanoic acid (PAP) do not require the use of a bleach activator or catalyst as these bleaches are active at relatively low temperatures such as 30° C.

The bleach catalyst may be a manganese complex comprising 1,4,7-Triazacyclononane (TACN), or any derivatives of a TACN ligand, for example 1,4,7-trimethyl-TACN, manganese oxalate, manganese acetate or a dinuclear manganese complex, for example a dinuclear manganese complex comprising TACN or any derivatives of a TACN ligand, for example 1,4,7-trimethyl-TACN.

Additionally, the object of the present invention is also solved by making use of such an inventive dishwashing, preferably an automatic dishwashing, detergent composition for silver corrosion protection of silver dishes during a dishwashing, preferably during an automatic dishwashing, process.

Furthermore, the object of the present invention is also solved by making use of a dishwashing, preferably an automatic dishwashing, detergent composition comprising tamarind extract, which comprises a mixture of reducing monosaccharides and reducing disaccharides for silver corrosion protection of silver dishes during a dishwashing, preferably during an automatic dishwashing, process.

Furthermore, the object of the present invention is also solved by a method of protecting silver ware from corrosion during a dishwashing process, the method comprising adding at least one reducing monosaccharide and/or at least one reducing disaccharide to the automatic dishwashing detergent composition.

Furthermore, the object of the present invention is also solved by a method of protecting silver ware from corrosion during a dishwashing process, the method comprising adding a tamarind extract comprising a mixture of reducing monosaccharides and reducing disaccharides to the automatic dishwashing detergent composition.

The following non-limiting examples are provided to illustrate an embodiment of the present invention and to facilitate understanding of the invention but are not intended to limit the scope of the invention, which is defined by the claims appended hereto.

### Experimental Part

The natural food product referred to in this invention is “tamarind” (scientific name: Tamarindus Indica L.). The complete extract of tamarind as well as selected components and their mixtures have been shown to demonstrate protection against silver corrosion in ADW compositions lacking the currently used BTA and/or TTA. In particular, the reducing sugars known to be in tamarind, namely a mixture of specific monosaccharides and disaccharides such as glucose, galactose, fructose, arabinose, lactose, melibiose, cellobiose, and maltose is demonstrated as a potential natural alternative in ADW formulations against silver corrosion for superior material care.

In the first case, the extract of the tamarind pulp from the common brown Indian variety was used. The tamarind fruit was extracted in warm water and the contents were directly tested against silver corrosion protection with a benchmark formula that does not contain BTA/TTA in the composition.

Followed by this, a selection of the reducing sugars in the tamarind pulp extract were commercially sourced and used in a mixture as the silver corrosion protection agent. Studies have shown that the common brown Indian variety of the tamarind fruit contains 25-45% of reducing sugars. In particular, depending on the plantation area, the fruit may contain a mixture of reducing mono- and disaccharides such as glucose, fructose, galactose, lactose, arabinose, as well as non-reducing sugars such as sucrose. A selection of reducing mono- and disaccharides, namely, cellobiose, melibiose, maltose, lactose, glucose, fructose, arabinose, and galactose in specific mixtures were tested.

The performance of the natural extract as well as the reducing sugar components was tested in beaker tests scored with a visual evaluation based on the level of tarnish.

### Experimental Conditions

Bench tests were performed to evaluate the extent of silver tarnishing in the presence of various silver corrosion protection agents. The test procedure used was as follows:

3L of water was heated to 50° C. in a 5 L beaker over 2 h and stirred for homogeneous heating. A benchmark formulation was dissolved in this water over 30 minutes allowing for complete dissolution. Followed by this, a silver corrosion protection agent (B1, T1, S1-S6, or 1a-8a) was added in an appropriate amount as described in Table 1 and Table 2. After 10 minutes, a silver fork/spoon/handle of a butter knife was suspended into the solution without any interference to the magnetic stir bar for continuous stirring of the solution. After 24 h, the silverware was removed from the beaker and dried under ambient conditions.

The silverware was then visually evaluated and scored from 1.0 (completely tarnished to black), 2.0 (Significant tarnish), 3.0 (acceptable tarnish), 4.0 (mild discoloration or shine loss), to 5.0 (not tarnished at all with almost to complete retention of shine and gloss) as an average of shine and gloss.

### Experimental Results

TABLE 1
Comparative and inventive formulations.

| | Formulation | | | | | | | | |
|---|---|---|---|---|---|---|---|---|---|
| Ingredient | BM-1 | BM-2 | | | F3 | | | | |
| (weight %) | Comp. | Comp. | F1 | F2 | Comp. | F4 | F5 | F6 | F7 |
| Sodium percarbonate | 14.4% | 14.4% | 14.4% | 14.4% | 14.4% | 14.4% | 14.4% | 14.4% | 14.4% |
| TAED | 3.4% | 3.4% | 3.4% | 3.4% | 3.4% | 3.4% | 3.4% | 3.4% | 3.4% |
| Tetrasodium-HEDP | 8.7% | 8.7% | 8.7% | 8.7% | 8.7% | 8.7% | 8.7% | 8.7% | 8.7% |
| Citric acid | 0.49% | 0.49% | 0.49% | 0.49% | 0.49% | 0.49% | 0.49% | 0.49% | 0.49% |
| Sulfonated polymer | 7.17% | 7.17% | 7.17% | 7.17% | 7.17% | 7.17% | 7.17% | 7.17% | 7.17% |
| Citrate trisodium salt | 26% | 26% | 26% | 26% | 26% | 26% | 26% | 26% | 26% |
| Polycarboxylate | 4.7% | 4.7% | 4.7% | 4.7% | 4.7% | 4.7% | 4.7% | 4.7% | 4.7% |
| polymer | | | | | | | | | |
| Sodium carbonate | 13.7% | 13.7% | 13.7% | 13.7% | 13.7% | 13.7% | 13.7% | 13.7% | 13.7% |
| Sodium bicarbonate | 3% | 3% | 3% | 3% | 3% | 3% | 3% | 3% | 3% |
| Non-ionic surfactant | 4.9% | 4.9% | 4.9% | 4.9% | 4.9% | 4.9% | 4.9% | 4.9% | 4.9% |
| Protease | 0.3% | 0.3% | 0.3% | 0.3% | 0.3% | 0.3% | 0.3% | 0.3% | 0.3% |
| Amylase | 0.4% | 0.4% | 0.4% | 0.4% | 0.4% | 0.4% | 0.4% | 0.4% | 0.4% |
| Silver corrosion agent | — | 1.0% | 1.0% | 1.0% | 1.0% | 1.0% | 1.0% | 1.0% | 1.0% |
| | | (B1) | (T1) | (S1) | (S2) | (S3) | (S4) | (S5) | (S6) |
| Score | 1.0 | 1.5 | 4.5 | 2.5 | 1.0 | 2.0 | 2.7 | 2.5 | 2.7 |

TABLE 2
Further comparative and inventive formulations.

| | Formulation | | | | | | | |
|---|---|---|---|---|---|---|---|---|
| Ingredient | F8 | | F10 | F11 | | | | |
| (weight %) | Comp. | F9 | Comp. | Comp. | F12 | F13 | F14 | F15 |
| Sodium percarbonate | 14.4% | 14.4% | 14.4% | 14.4% | 14.4% | 14.4% | 14.4% | 14.4% |
| TAED | 3.4% | 3.4% | 3.4% | 3.4% | 3.4% | 3.4% | 3.4% | 3.4% |
| Tetrasodium-HEDP | 8.7% | 8.7% | 8.7% | 8.7% | 8.7% | 8.7% | 8.7% | 8.7% |
| Citric acid | 0.49% | 0.49% | 0.49% | 0.49% | 0.49% | 0.49% | 0.49% | 0.49% |
| Sulfonated polymer | 7.17% | 7.17% | 7.17% | 7.17% | 7.17% | 7.17% | 7.17% | 7.17% |
| Citrate trisodium salt | 26% | 26% | 26% | 26% | 26% | 26% | 26% | 26% |
| Polycarboxylate | 4.7% | 4.7% | 4.7% | 4.7% | 4.7% | 4.7% | 4.7% | 4.7% |
| polymer | | | | | | | | |
| Sodium carbonate | 13.7% | 13.7% | 13.7% | 13.7% | 13.7% | 13.7% | 13.7% | 13.7% |
| Sodium bicarbonate | 3% | 3% | 3% | 3% | 3% | 3% | 3% | 3% |
| Non-ionic surfactant | 4.9% | 4.9% | 4.9% | 4.9% | 4.9% | 4.9% | 4.9% | 4.9% |
| Protease | 0.3% | 0.3% | 0.3% | 0.3% | 0.3% | 0.3% | 0.3% | 0.3% |
| Amylase | 0.4% | 0.4% | 0.4% | 0.4% | 0.4% | 0.4% | 0.4% | 0.4% |
| Silver corrosion agent | 1.0% | 0.5% | 0.5% | 0.5% | 1.0% | 0.5% | 1.0% | 0.5% |
| | (1a) | (2a) | (3a) | (4a) | (5a) | (6a) | (7a) | (8a) |
| Score | 1.0 | 1.5 | 1.0 | 1.0 | 2.2 | 3.0 | 3.0 | 3.5 |

TABLE 3
Individual silver corrosion protection
compounds used in the examples

| Silver corrosion | | | | | | | | |
|---|---|---|---|---|---|---|---|---|
| protection agent | | | | | | | | |
| (1.0 weight %) | T1 | B1 | S1 | S2 | S3 | S4 | S5 | S6 |
| BTA | − | + | − | − | − | − | − | − |
| Tamarind extract | + | − | − | − | − | − | − | − |
| Glucose | − | − | + | − | − | − | − | − |
| Sucrose | − | − | − | + | − | − | − | − |
| Lactose | − | − | − | − | + | − | − | − |
| Maltose | − | − | − | − | − | + | − | − |
| Cellobiose | − | − | − | − | − | − | + | − |
| Melibiose | − | − | − | − | − | − | − | + |

TABLE 4
Mixtures of individual silver corrosion protection
compounds used in the examples.

| Silver corrosion | | | | | | | | |
|---|---|---|---|---|---|---|---|---|
| protection agent | 1a | 2a | 3a | 4a | 5a | 6a | 7a | 8a |
| Glucose | + | + | + | + | − | + | − | − |
| Sucrose | − | + | − | − | − | − | − | − |
| Lactose | + | + | + | + | − | − | + | − |
| Maltose | + | + | + | + | − | + | + | − |
| Cellobiose | + | + | − | + | + | + | + | + |
| Melibiose | + | + | − | + | + | + | + | + |
| Fructose | + | − | − | − | − | − | − | − |
| Arabinose | + | − | − | − | − | − | − | − |
| Galactose | + | − | − | − | − | − | − | − |

The present invention thus addresses the problem of providing a new alternative composition for silver protection in dishwashing processes, which can reduce on the one hand the release of harmful and less biodegradable benzotriazoles into the environment; while being on the other hand of comparable efficacy in inhibiting silver corrosion compared to the use of compositions comprising BTA and/or TTA.

While the principles of the invention have been explained in relation to certain particular embodiments, and are provided for purposes of illustration, it is to be understood that various modifications thereof will become apparent to those skilled in the art upon reading the specification. Therefore, it is to be understood that the invention disclosed herein is intended to cover such modifications as fall within the scope of the appended claims. The scope of the invention is limited only by the scope of the appended claims.

1. A dishwashing detergent composition characterized in that the detergent composition comprises at least one reducing monosaccharide and/or at least one reducing disaccharide.

2. The dishwashing detergent composition according to claim 1 characterized in that the detergent composition is essentially free of any triazole.

3. The dishwashing detergent composition according to claim 1 characterized in that the at least one reducing monosaccharide is selected from the group consisting of glucose, fructose, galactose, deoxyribose, ribose, xylose, arabinose, lyxose, allose, altrose, mannose, gulose, iodose, and talose.

4. The dishwashing detergent composition according to claim 1 characterized in that the at least one reducing disaccharide is selected from the group consisting of maltose, lactose, cellobiose, melibiose, chitobiose, kojibiose, nigerose, Isomaltose, sophorose, laminaribiose, gentiobiose, trehalulose, turanose, maltulose, leucrose, isomaltulose, gentiobiulose, mannobiose, melibiulose, rutinose, rutinulose, and xylobiose.

5. The dishwashing detergent composition according to claim 1 characterized in that the at least one reducing monosaccharide is selected from the group consisting of glucose, fructose, galactose, and arabinose; while the at least one reducing disaccharide is selected from the group consisting of maltose, lactose, cellobiose, and melibiose.

6. The dishwashing detergent composition according to claim 1 characterized in that the detergent composition further comprises at least one non-reducing monosaccharide and/or at least one non-reducing disaccharide.

7. The dishwashing detergent composition according to claim 6 characterized in that the detergent composition further comprises at least sucrose and/or trehalose.

8. The dishwashing detergent composition according to claim 1 characterized in that the detergent composition is essentially free, preferably completely free, of any non-reducing monosaccharide and non-reducing disaccharide.

9. The dishwashing detergent composition according to claim 1 characterized in that the detergent composition comprises at least two different reducing disaccharides.

10. The dishwashing detergent composition according to claim 9 characterized in that the detergent composition comprises two different reducing disaccharides with the proviso that no other reducing monosaccharides or reducing disaccharides are comprised.

11. The dishwashing detergent composition according to claim 10 characterized in that the two different reducing disaccharides are cellobiose and melibiose.

12. The dishwashing detergent composition according to claim 1 characterized in that the detergent composition is essentially free of any other reducing agent besides reducing monosaccharides and/or reducing disaccharides.

13. The dishwashing detergent composition according to claim 1 characterized in that said detergent composition comprises 0.1 to 5 wt % of said reducing monosaccharides and reducing disaccharides in total.

14. Use of a dishwashing detergent composition according to claim 1 for silver corrosion protection of silver dishes during a dishwashing process.

15. Use of a dishwashing detergent composition comprising tamarind extract, which comprises a mixture of reducing monosaccharides and reducing disaccharides for silver corrosion protection of silver dishes during a dishwashing process.

16. The dishwashing detergent composition according to claim 5 characterized in that the detergent composition is essentially free of any triazole.

17. The dishwashing detergent composition according to claim 16 characterized in that the detergent composition further comprises at least one non-reducing monosaccharide and/or at least one non-reducing disaccharide.

18. The dishwashing detergent composition according to claim 9 characterized in that the detergent composition is essentially free of any triazole.

19. The dishwashing detergent composition according to claim 18 characterized in that the at least one reducing monosaccharide is selected from the group consisting of glucose, fructose, galactose, and arabinose; while the at least one reducing disaccharide is selected from the group consisting of maltose, lactose, cellobiose, and melibiose.

20. The dishwashing detergent composition according to claim 10 characterized in that the detergent composition is essentially free of any triazole.
